(19) United States
(12) Patent Application Publication
(10) Pub. No.: US 2014/0116835 A1
(43) Pub. Date: May 1, 2014

(54) VEHICLE PARK LOCK ASSEMBLY

(71) Applicant: FORD GLOBAL TECHNOLOGIES, LLC, DEARBORN, MI (US)

(72) Inventor: Bradley R. Heuver, South Lyon, MI (US)

(73) Assignee: FORD GLOBAL TECHNOLOGIES, LLC, DEARBORN, MI (US)

(21) Appl. No.: 13/664,692

(22) Filed: Oct. 31, 2012

(51) Int. Cl. B60W 10/196

(52) U.S. Cl. 192/219.5

(57) ABSTRACT

A park assembly includes a park gear, a pawl that engages and disengages the park gear, a park rod that causes the pawl to engage with the park gear and to disengage from the park gear, a servo, and a bellcrank transmitting a first force to the park rod causes the pawl to disengage from the park gear in response to a second force substantially greater than the first force and produced by the servo.

### BACKGROUND OF THE INVENTION

1. Field of the Invention

This invention relates to a parking brake mechanism for an automatic transmission and, more particularly, to a park mechanism actuated by a servo to alternately engage and disengage the park gear of a vehicle.

2. Description of the Prior Art

Parking mechanisms or assemblies are used in automotive vehicles to allow the vehicle to enter into and maintain a “parked” condition or state. Parking assemblies typically include a park rod or cam which selectively actuates a parking pawl which operatively engages the vehicle's park gear, thereby maintaining the vehicle in a “parked” position or state.

The park rod is typically mechanically linked to the vehicle's shifter and moves in response to shifter movement. When the shifter is moved to the “park” position, the park rod engages the parking pawl, which pivots or rotates into a position where it is disposed between a pair of teeth on the park gear, thereby substantially preventing the park gear and the output shaft from further rotating.

In a shift-by-wire park system, a spring apply-servo release system requires a force of about 100 pounds to pull the apply rod out of park when the vehicle is fully loaded on a grade. This force requires a large servo to conduct the event. A need exits to reduce the magnitude of force needed such that a smaller servo mechanism can be employed.

### SUMMARY OF THE INVENTION

A park assembly includes a park gear, a pawl that engages and disengages the park gear, a park rod that causes the pawl to engage with the park gear and to disengage from the park gear, a servo, and a bellcrank transmitting a first force to the park rod causes the pawl to disengage from the park gear in response to a second force substantially greater than the first force and produced by the servo.

By utilizing a cam driven park rod and servo valve, the force amplification effects of the cam profile on the bellcrank reduces the size of the servo valve 28, thereby reducing its cost less, weight, and packaging difficulty.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a perspective front view of a park brake assembly for an automatic transmission;

FIG. 2 is a perspective rear view of a park brake assembly shown in FIG. 1;

FIG. 3 is a rear view of a portion of the assembly shown in FIG. 1;

FIG. 4 is a perspective front view of a slotted bellcrank of the park brake assembly; and

FIG. 5 is schematic diagram showing the servo force amplified and transmitted by the bellcrank to the park rod.

### DESCRIPTION OF THE PREFERRED EMBODIMENT

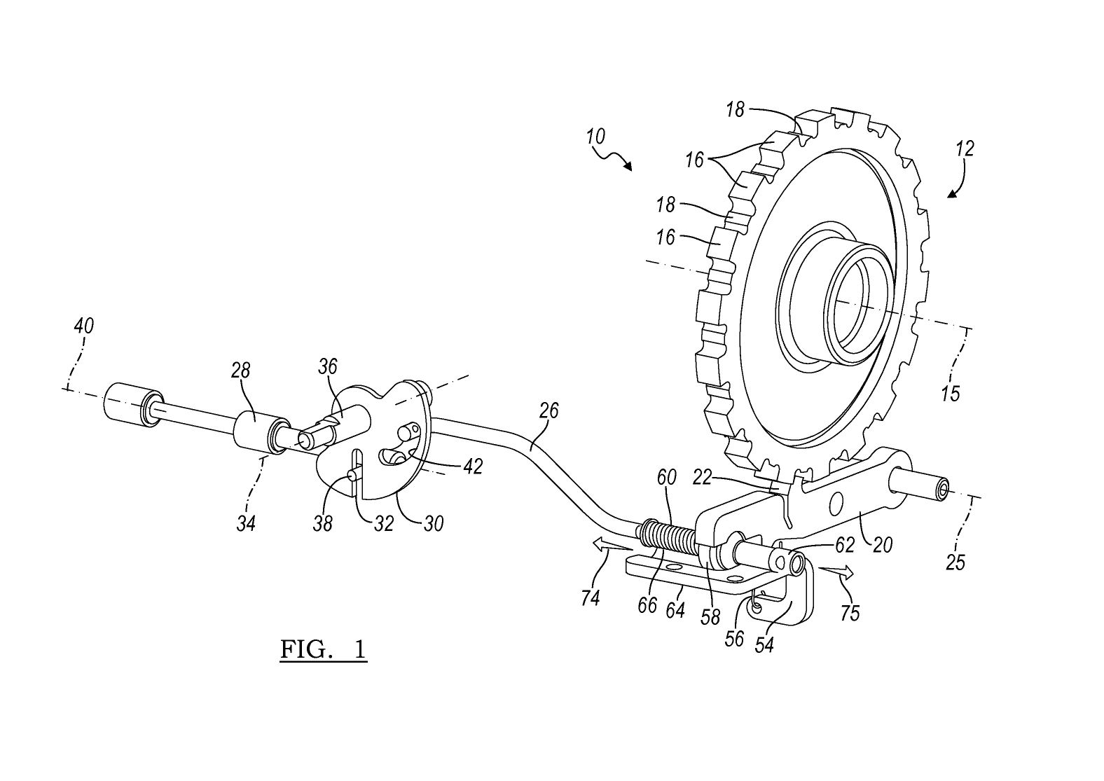

FIG. 1 illustrates the components of a park assembly 10, adapted for use in combination with a vehicle of the type having a park gear 12 and a shifter (not shown) for selecting the operating range of an automatic transmission, whose output shaft is aligned with axis 15 and secured to park gear 12 .

Park gear 12 includes several peripherally disposed and substantially identical teeth or projections 16. Each tooth 16 is separated by a cavity or recess 18. A parking pawl 20, which includes a tooth 22, pivots about axis 24 to engage park gear 12, thereby substantially preventing the park gear 12 and output shaft from rotating. When pawl 20 is disengaged from park gear 12, output shaft is free to rotate about axis 25.

The shifter is operatively and selectively movable among several positions, such as a “park” position, a “reverse” position, a “neutral” position, and a “drive” position, which respectively correspond to various operating states or operating ranges modes of the transmission. The shifter may be a push-button shifter.

Park assembly 10 further includes a park rod 26, and a servo 28, which is preferably a hydraulic valve that responds to movement of the shifter to actuate park rod 26.

A bellcrank 30 includes a slot 32, which extends radially from the axis 34 of a pin 36, about which bellcrank 30 is supported in rotation. Valve 28 includes a pin 38, located in slot 32. As valve 28 moves along axis 40 in response to movement of the shifter, pin 38 causes bellcrank 30 to pivot about axis 34. Park rod 26, fitted in an arcuate slot 42 formed in bellcrank 30, displaces the park rod 26. A bracket 46, secured against displacement, is formed with mutually parallel slots 48, 50. Locating park rod 26 in slot 48 ensures that the end of park rod moves parallel to axis 40. Locating pin 38 in slot 50 ensures that valve pin 38 moves parallel to axis 40.

A bracket 54, secured against displacement, supports a return spring 56. The force of return spring 56 biases park pawl 20 to pivot toward engagement with a cam 58 and away from engagement with park gear 12. Cam 58 can move along park rod 26. A compression spring 60 on park rod 26 continually urges cam 58 toward an end of the park rod toward a stop 62, which limits that displacement. Spring 60 also allows cam 58 to move along the park rod 26 and away from pawl 20 by compressing the spring.

A plate 64, fixed against displacement, is formed with a longitudinal recess 66 directed toward pawl 20. Cam 58 is fitted in recess 66 and is guided to move along the recess alternately in the direction of the arrows 74, 75, thereby defining the location of cam 58 and direction of its movement.

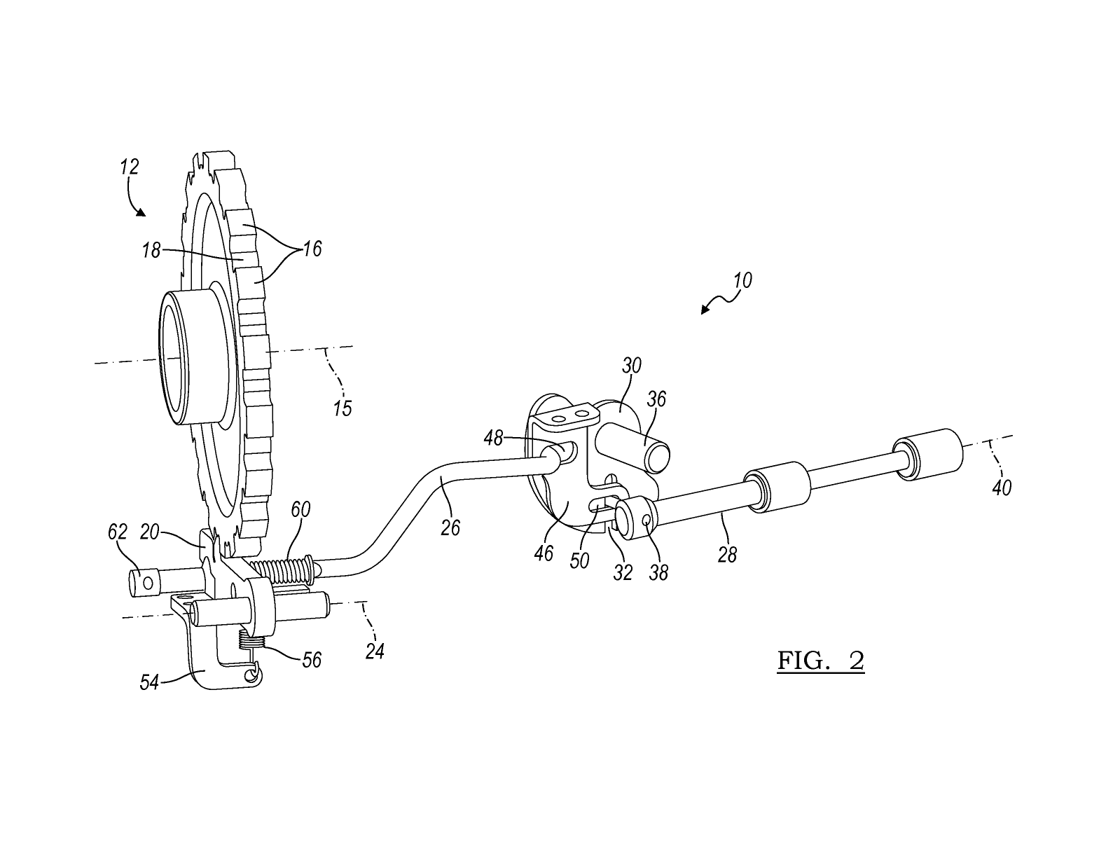

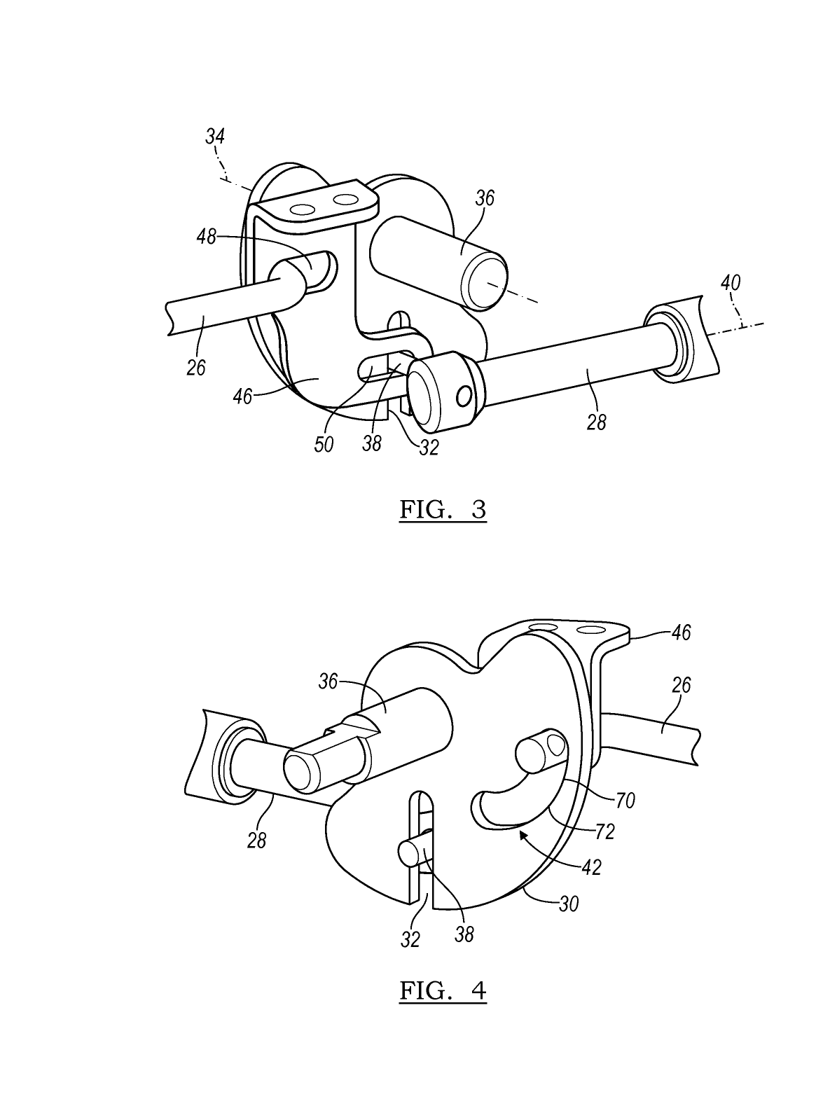

FIGS. 1-4 show the assembly 10 in the park position. Slot 42 comprises two cam profiles 70 and 72. When the shifter is moved out of the park position, the servo valve 28 pivots bellcrank 30 counterclockwise as viewed in FIGS. 1 and 4, causing park rod 26 to be guided first along the periphery of cam profile 70 in the bellcrank 30. Profile 70 pulls the park rod 26 in the direction of arrow 74 with a controlled mechanical advantage of about 5:1, i.e., the force applied by the profile 70 of slot 42 to park rod 26 is about five times greater than the force applied by valve 28 to slot 32 of bellcrank 30.

As park rod 26 moves in the direction of arrow 74 cam 58 disengages from pawl 20, causing the pawl tooth 22 to disengage from and releasing park gear 12. Spring 56 holds pawl member 20 in the disengaged position until the next engagement sequence.

This force amplification allows a small valve to pull with a large force. After the pull-out-of-park event has occurred, cam profile 72 accelerates movement of the park rod to the no-park position, where the end of park rod 26 is at the end of slot 42 at the base of profile 72.

In the park assembly 10, ratcheting which may occur when a vehicle is unintentionally shifted to park while the vehicle is still moving, is prevented. If a shift into park is allowable, valve 28 and park rod 26 move in the direction of arrow 75, thereby causing cam 58 to engage parking pawl 20 and forcing the pawl into engagement with park gear 12.

By utilizing a cam driven park rod 26 and servo valve 28, the force amplification effects of the cam profile 70 reduce the size of the servo valve 28. The assembly 10 provides the travel needed to move the park rod 26 from the park position to the no-park position.

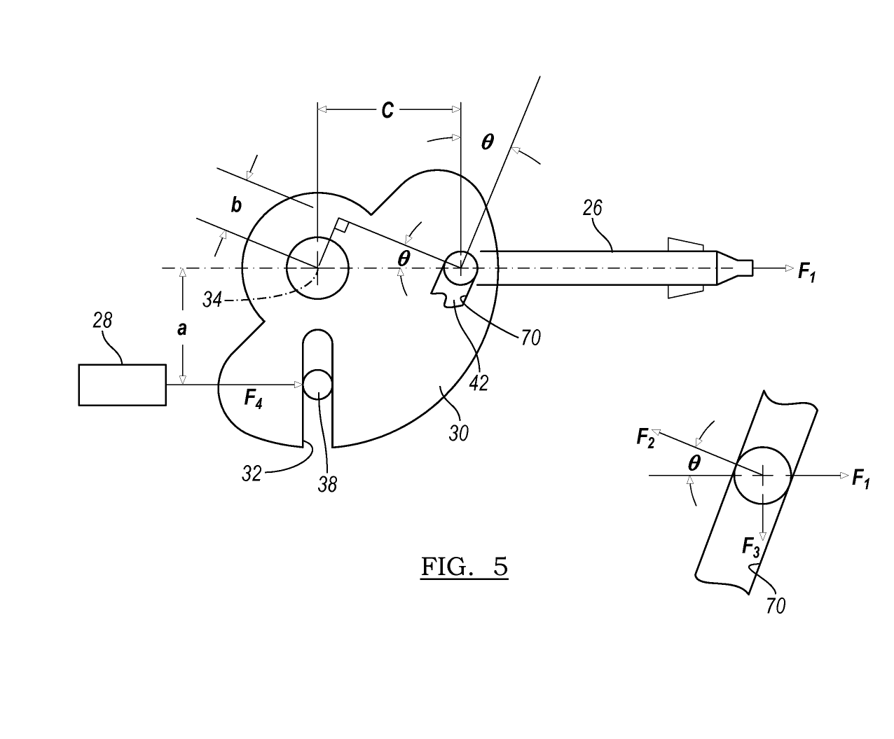

FIG. 5 is schematic diagram showing the servo force F4 and the park rod force F1 applied to the bellcrank 30 to disengage the park rod 26 from the pawl and to disengage the pawl 20 from park gear 12. Forces F2 and F3 represent the components of the F1 when applied to the cam profile 70. Angle θ represents the angle of the cam profile 70 on the bellcrank with respect to the vertical axis. With reference to the forces at the interface between park rod 26 and the cam profile 70

F2 cos θ=F1 (1)

F2 sin θ=F3 (2)

From a summation of moments about pivot axis 34

F2(b)=F4(a) (3)

Substituting from equations (1) and (2) into equation (3)

[F1/cos θ][c sin θ]=F4(a)

Tan θ=F4(a)/F1(c) (4)

In this example θ=9.3 degrees; the servo force F4 is 22 lb.; distance a is 25 mm. and distance c is 30 mm. Substituting these variables in equation (4) shows that F1 is about 112 lbs, indicating that bellcrank 30 produces a mechanical advantage of about five. The force F1 applied by the bellcrank to park rod 26 is about five times greater than the servo force F1 applied to the bellcrank.

In accordance with the provisions of the patent statutes, the preferred embodiment has been described. However, it should be noted that the alternate embodiments can be practiced otherwise than as specifically illustrated and described.

The invention claimed is:

1. A park assembly, comprising:
a park gear;
a pawl;
a park rod that causes the pawl to engage with the park gear and to disengage from the park gear;
a servo;
a bellcrank transmitting a first force to the park rod that causes the pawl to disengage from the park gear in response to a second force less than the first force, produced by the servo and applied to the bellcrank.

2. The park assembly of claim 1, wherein:
the park gear includes teeth and a space between each of the teeth, the teeth and spaces being located on a periphery of the park gear; and
the pawl is supported to pivot and includes a tooth that alternately engages one of the spaces to prevent rotation of the park gear and disengages the spaces to permit rotation of the park gear.

3. The park assembly of claim 1, wherein:
the park gear includes teeth and a space between each of the teeth, the teeth and spaces being located on a periphery of the park gear; and
the pawl is supported to pivot and includes a tooth that alternately engages one of the spaces to prevent rotation of the park gear and disengages the spaces to permit rotation of the park gear; and
further comprising a spring that urges the pawl away from engagement with the park gear and toward engagement with the park rod.

4. The park assembly of claim 1, wherein the park rod further comprises:
a cam supported for displacement along a length of the park rod;
a second spring for urging the cam toward alignment with the pawl; and
a stop for limiting said displacement in a first longitudinal direction.

5. The park assembly of claim 1, further comprising:
a cam supported for displacement along a length of the park rod;
a second spring for urging the cam toward alignment with the pawl;
a stop for limiting said displacement in a first longitudinal direction; and
a plate having a recess directed toward the pawl, displacement of the cam being guided by contact between the recess.

6. The park assembly of claim 1, further comprising:
a bracket having a first slot, directed toward the pawl, a portion of the park rod located in the first slot for guiding displacement of the park rod.

7. The park assembly of claim 1, further comprising:
a bracket having a second slot, directed toward the pawl, a portion of the servo located in the second slot for guiding displacement of the park rod.

8. The park assembly of claim 1, wherein the bellcrank further comprises:
a pivot axis;
a first slot directed substantially radially with respect to the pivot axis, the second force being applied to the bellcrank due to contact between a portion of the servo located in the first slot and a surface of the first slot.

9. The park assembly of claim 1, wherein the bellcrank further comprises:
a pivot axis;
a first slot directed substantially radially with respect to the pivot axis, the second force being applied to the bellcrank due to contact between a portion of the servo located in the first slot and a surface of the first slot;
a second slot having a first cam profile, the second force being applied by the bellcrank to a portion of the park rod located in the second slot due to contact between the first cam profile and said portion of the park rod.

10. The park assembly of claim 1, wherein the bellcrank further comprises:
a second slot having a first cam profile and a second cam profile extending from the first cam profile, movement of the park rod in the second slot along the second cam profile permitting the park rod to move away from the pawl and the park gear to be disengaged by the pawl.

11. A park assembly for use in combination with a vehicle having a park gear, comprising:
a pawl;
a park rod that causes the pawl to engage with the park gear and to disengage from the park gear;
a servo;
a bellcrank transmitting a first force to the park rod that causes the pawl to disengage from the park gear in response to a second force less than the first force, produced by the servo and applied to the bellcrank.

12. The park assembly of claim 11, wherein:
the park gear includes teeth and a space between each of the teeth, the teeth and spaces being located on a periphery of the park gear; and
the pawl is supported to pivot and includes a tooth that alternately engages one of the spaces to prevent rotation of the park gear and disengages the spaces to permit rotation of the park gear; and
further comprising a spring that urges the pawl away from engagement with the park gear and toward engagement with the park rod.

13. The park assembly of claim 11, wherein the park rod further comprises:
a cam supported for displacement along a length of the park rod;
a second spring for urging the cam toward alignment with the pawl; and
a stop for limiting said displacement in a first longitudinal direction.

14. The park assembly of claim 11, further comprising:
a cam supported for displacement along a length of the park rod;
a second spring for urging the cam toward alignment with the pawl;
a stop for limiting said displacement in a first longitudinal direction; and
a plate having a recess directed toward the pawl, displacement of the cam being guided by contact between the recess.

15. The park assembly of claim 11, wherein the bellcrank further comprises:
a pivot axis;
a first slot directed substantially radially with respect to the pivot axis, the second force being applied to the bellcrank due to contact between a portion of the servo located in the first slot and a surface of the first slot;
a second slot having a first cam profile, the second force being applied by the bellcrank to a portion of the park rod located in the second slot due to contact between the first cam profile and said portion of the park rod.

16. The park assembly of claim 11, wherein the bellcrank further comprises:
a second slot having a first cam profile and a second cam profile extending from the first cam profile, movement of the park rod in the second slot along the second cam profile permitting the park rod to move away from the pawl and the park gear to be disengaged by the pawl.

17. A method for operating a park assembly, comprising:
(a) providing a pawl that engage with and disengages from a park gear;
(b) using a servo to pivot a bellcrank in a first direction that transmits a first force to a park rod causing the pawl to disengage from the park gear in response to a second force less than the first force, produced by the servo and applied to the bellcrank.

18. The method of claim 17, wherein step (b) further comprises:
fitting a portion of the servo in a first slot formed on the bellcrank and spaced from an axis about which the bellcrank pivots; and
actuating the servo to producing the second force.

19. The method of claim 17, wherein step (b) further comprises:
producing on the bellcrank a cam profile;
guiding movement of the park rod along the cam profile;
transmitting the first force to the park rod as the park rod moves along the cam profile.

20. The method of claim 17, further comprising:
producing on the bellcrank a second cam profile;
using a servo to pivot the bellcrank in a second direction opposite the first direction;
permitting the park rod to travel among the second cam profile as the park rod disengages from the pawl and the pawl disengages from the park gear.
